(19) United States
(12) Patent Application Publication
(10) Pub. No.: US 2006/0242412 A1
(43) Pub. Date: Oct. 26, 2006

(54) Method and communication system for configuring security information in WLAN

(75) Inventors: Bae-eun Jung, Seongnam-si (KR); Mi-suk Huh, Suwon-si (KR); Kyung-hee Lee, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/355,961

(22) Filed: Feb. 17, 2006

(30) Foreign Application Priority Data
Apr. 25, 2005 (KR) 2005-0034007

(51) Int. Cl. H04L 9/00

(52) U.S. Cl. 713/171

(57) ABSTRACT

A communication system including a device, an access point (AP) communicating with the device, and a mobile terminal communicating with the device and the AP, and a method in which the device and the AP share a device key that is a private key used in wireless local area network (WLAN) communication, are provided. A one-directional function operation module is provided in each component constituting the communication system, thereby enabling one-directional function operation. Data to be transmitted and received is applied to one-directional function operation in one-directional function operation module, such that the data can be securely transmitted or received.

### CROSS-REFERENCE TO RELATED APPLICATIONS

This application claims the benefit under 35 U.S.C. §119(a) of a Korean Patent Application No. 2005-34007, filed on Apr. 25, 2005, the entire content of which is hereby incorporated by reference.

### BACKGROUND OF THE INVENTION

1. Field of the Invention

The present invention relates to a method and system for configuring security information in a wireless local area network (WLAN). More particularly, the present invention relates to a method and system for configuring security information between a device and an access point (AP) that constitute a WLAN.

2. Description of the Related Art

In the present times, wired LAN communication used for Internet access in offices, schools, etc is being substituted by wireless communication such as 802.11 WLAN communication, Bluetooth communication, or infrared communication. The WLAN is called as Wi-Fi because the wireless network is conveniently available, like a HiFi audio system. The WLAN permits access to high-speed Internet with a PDA or a notebook computer within a certain distance around an access point (AP). The use of the WLAN does not require a telephone wire or a private cable because it uses a wireless resource but needs a PDA or notebook computer with a WLAN card. Initially, the WLAN had coverage of up to 10 m. In the 21^{st} century, the coverage has significantly widened to about 50 to 200 m. The WLAN enables massive multimedia information to be transferred at a rate of 4 to 11 Mbps.

As a need for high-speed wireless Internet increases, the WLAN becomes the choice infrastructure for high-speed wireless public networks. The WLAN is spotlighted because it can overcome the low transmission rate of mobile communication systems and guarantee secure communication for a WLAN user by using advanced security technology. In the WLAN, security technology as well as an improved wireless transmission rate are especially required.

Devices constituting the WLAN communicate with external networks or other devices using wireless resources. Generally, the wireless resources are easily exposed to attack from others compared to wired resources. Thus, there is a need for a technique for performing secure communication between a device and an AP.

### SUMMARY OF THE INVENTION

Certain embodiments of the present invention address the above-described problem. Accordingly, it is an object of the present invention to provide a technique of sharing a device key to facilitate secure communication between a device and an access point (AP).

Another object of the present invention is to provide a technique of securely discarding a device key that is shared between a device and an AP constituting a wireless local area network (WLAN).

The above exemplary objects of the present invention may be realized by providing a communication system, which may comprise a device, an access point (AP) communicating with the device, and a mobile terminal communicating with the device and the AP, and a method in which a mobile terminal shares a private key with the AP, where a private key configuration request message is transmitted to the AP. A private key configuration request message may comprise network information of the mobile terminal. A private key configuration response message is received from the AP, the private key configuration response message comprising network information of the AP, the private key corresponding to the AP network information is generated, and a private key configuration information message comprising the generated private key is transmitted.

In accordance with an exemplary embodiment of the present invention, there are provided a communication system, which may comprise a device, an access point (AP) communicating with the device, and a mobile terminal communicating with the device and the AP, and a method in which a mobile terminal shares a device key with the device, where a device key configuration request message is transmitted to the device. A device key configuration response message is received from the device, the device key configuration response message including network information of the device. The device key is generated based on a stored private key, a count, and the received network information of the device, and a device key configuration information message including the generated device key is transmitted.

In accordance with yet another exemplary embodiment of the present invention, there are provided a communication system, which may comprise a device, an access point (AP) communicating with the device, and a mobile terminal communicating with the device and the AP, and a method in which a device shares a device key with the AP, where a WPA configuration request message is sent, the WPA configuration request message including a randomly generated random 1, with a MAC address of the device and a count that are used to generate the device key. An authentication WPA configuration request message is received, the authentication WPA configuration request message including a first one-directional function operation value obtained by applying the random 1 to one-directional function operation, and a randomly generated random 2. When a value obtained by applying the random 1 to the one-directional function operation is equal to the first one-directional function operation value, an authentication WPA configuration response message is sent, the authentication WPA configuration response message including a second one-directional function operation value obtained by applying the received random 2 to the one-directional function operation.

In accordance with yet another exemplary embodiment of the present invention, there are provided a communication system, which may comprise a device, an access point (AP) communicating with the device, and a mobile terminal communicating with the device and the AP, and a method in which a mobile terminal instructs the device to discard a stored device key, where a device key discard request message is sent, the device key discard request message including a randomly generated random a and network information of the AP. An authentication device key discard request message is received, the authentication device key discard request message including an a-th one-directional function operation value obtained by applying the random a and a pre-stored device key to one-directional operation, a randomly generated random b, and network information of the device. The device key is generated using a stored private key and the received network information of the device, and an authentication device key discard response message is sent when a value obtained by applying the generated device key and the random a to the one-directional operation is equal to the a-th one-directional function operation value, the authentication device key discard response message including a b-th one-directional function operation value obtained by applying the received random b to the one-directional function operation.

In accordance with yet another exemplary embodiment of the present invention, there are provided a communication system, which may comprise a device, an access point (AP) communicating with the device, and a mobile terminal communicating with the device and the AP, and a method in which a mobile terminal instructs the AP to discard a stored device key, where a WPA discard request message is sent, the WPA discard request message including a randomly generated random c and network information of the AP. An authentication WPA discard request message is received, the authentication WPA discard request message including a c-th one-directional function operation value obtained by applying the random c and a pre-stored device key to one-directional operation, and a randomly generated random d. When a value obtained by applying the pre-stored device key and the receiving random c to the one-directional operation is equal to the c-th one-directional function operation value, an authentication WPA discard response message is sent, the authentication WPA discard response message including a d-th one-directional function operation value obtained by applying the received random d to the one-directional function operation.

### BRIEF DESCRIPTION OF THE DRAWINGS

The above aspects and features of the present invention will be more apparent by describing certain embodiments of the present invention with reference to the accompanying drawings, in which like reference numerals will be understood to refer to like parts, components and structures, where:

FIG. 1 illustrates a wireless local area network (WLAN) including a mobile terminal, a device, and an access point (AP) according to an exemplary embodiment of the present invention;

FIG. 2 illustrates a process in which a mobile terminal and an AP share a private key therebetween according to an exemplary embodiment of the present invention;

FIG. 3 illustrates a process in which a device and an AP share a device key therebetween according to an exemplary embodiment of the present invention; and

FIG. 4 illustrates a process in which a device and an AP discard stored information according to an exemplary embodiment of the present invention.

### DETAILED DESCRIPTION OF EXEMPLARY EMBODIMENTS

Certain exemplary embodiments of the present invention will be described in detail with reference to the annexed drawings. In the drawings, as noted above, the same elements are denoted by the same reference numerals throughout the drawings. In the following description, detailed descriptions of known functions and configurations incorporated herein have been omitted for conciseness and clarity.

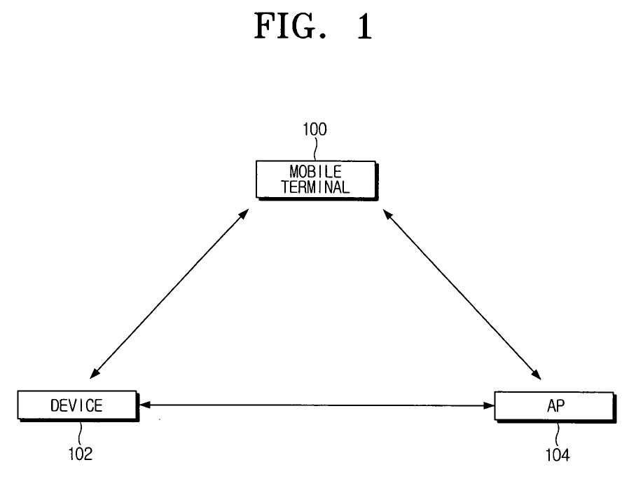

FIG. 1 shows components constituting a wireless local area network (WLAN) according to an exemplary embodiment of the present invention. The WLAN includes a device 102, an access point (AP) 104, and a mobile terminal (relaying terminal) 100. The WLAN generally includes at least one device and at least one AP. For convenience of illustration, FIG. 1 shows only one device 102 and one AP 104. The characteristic of each device forming the WLAN will be explained hereinafter.

The mobile terminal 100 is portable, like a mobile phone or a personal digital assistant (PDA) phone, and provides a user interface (UI). The mobile terminal 100 includes an infrared communication module for enabling infrared communication, and a one-directional function algorithm module for generating keys.

The device 102 performs wireless communication with the AP 104 over a wireless channel and infrared communication with the mobile terminal 100 over an infrared channel. Even though the infrared channel is one of wireless channels, the infrared channel and the wireless channel are used herein as distinct mediums. The device 102 includes an infrared communication module for enabling infrared communication and a one-directional function algorithm module for generating keys.

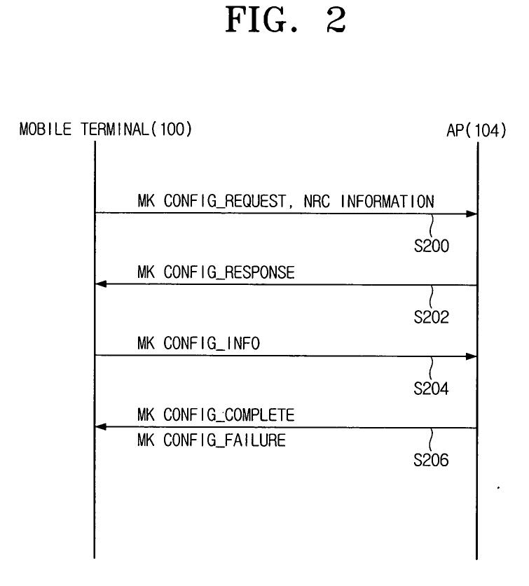

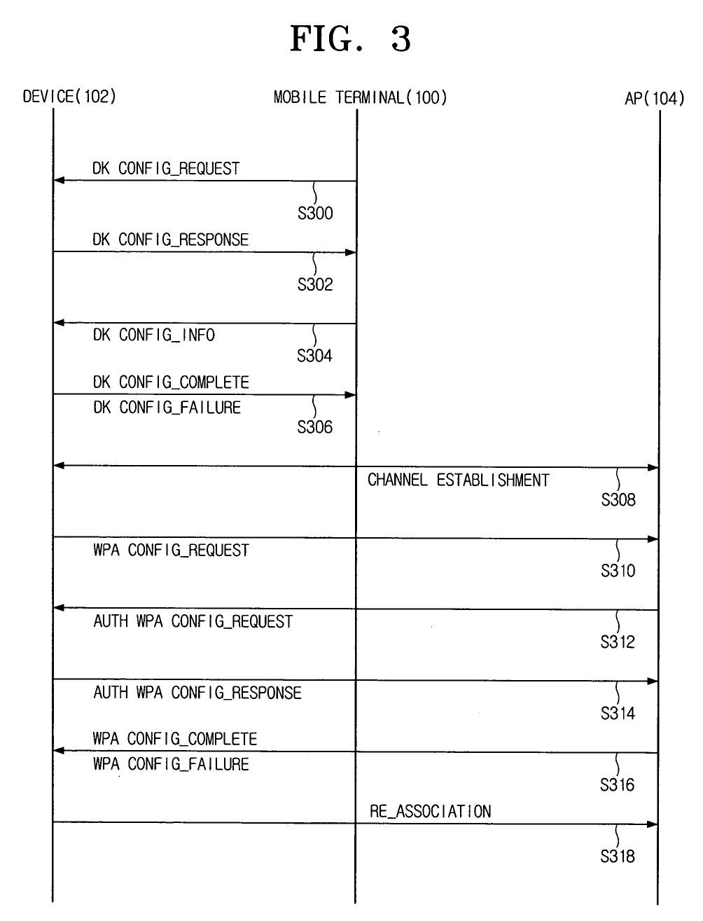

The AP 104 includes an infrared communication module for enabling infrared communication with the mobile terminal 100. The AP 104 and the device 102 sharing a private key therebetween will be described with reference to FIGS. 2 and 3.

FIG. 2 shows a process in which an AP 104 and a mobile terminal 100 share a private key therebetween according to an exemplary embodiment of the present invention.

The mobile terminal 100 has an AP mode in which the mobile terminal 100 communicates with the AP 104 and a device mode in which the mobile terminal 100 communicates with the device 102. The mobile terminal 100 is switched to the AP mode to share a private key with the AP 104. The mobile terminal 100 initializes stored parameter values prior to communicating with the AP 104. The AP 104 initializes a count and a service set identifier (SSID). The SSID is a unique identifier of 32 bytes that constitutes a header of a packet that is transferred over the WLAN. If a plurality of APs constitute the WLAN, each AP has a unique SSID. The device 102 wirelessly communicates with the AP 104 that is specified by the SSID.

The mobile terminal 100 sends a private key configuration request message (MKconfig_request message) with mobile terminal information to the AP 104 over the infrared channel (S200). The private key configuration request message is a message for requesting to initiate a private key configuration mode in which a private key is configured. The mobile terminal 100 transmits and receives necessary messages and information to and from with the AP 104 over the infrared channel. The mobile terminal information contained in the private key configuration request message includes network information of the mobile terminal 100.

In response to receiving the private key configuration request message, the AP 104 checks whether a private key for the mobile terminal 100 is stored. In addition, the AP 104 searches for an SSID that is network information of the AP.

The AP 104 transmits a private key configuration response message (MKconfig_response message) including the SSID to the mobile terminal 100 over the infrared channel (S202). The private key configuration response message indicates that the AP 104 can receive a new private key. In response to receiving the private key configuration response message, the mobile terminal 100 determines whether the same SSID as the received SSID is stored. If the same SSID as the received SSID is stored, the mobile terminal 100 generates and stores a new private key. In this case, the mobile terminal 100 stores the private key associated with the stored SSID.

If the same SSID as the received SSID is not stored, the mobile terminal 100 assigns a memory area to store the received SSID in the memory and generates and stores a random private key. In response to receiving the private key configuration response message, the mobile terminal 100 increments a count by one. If the same SSID as the received SSID is not stored, the mobile terminal 100 does not have a stored private key associated with the SSID.

The mobile terminal 100 transmits a private key configuration information message (MKconfig_info message) to the AP 104 over the infrared channel (S204). The private key configuration information message includes an old private key and the newly generated (or the randomly generated) private key count. If there is no old private key, that is if the same SSID as the received SSID is not stored, the mobile terminal 100 represents information about the old private key as null.

In response to receiving the private key configuration information message, the AP 104 determines whether the received old private key is the same as a stored private key. If the received old private key is the same as the stored private key, the AP 104 transmits a private key configuration complete message (MKconfig_complete message) to the mobile terminal 100 over the infrared channel (S206). The AP 104 updates a table with the information contained in the private key configuration message. The mobile terminal 100 then notifies the user that private key share is terminated. That is, the mobile terminal 100 notifies the user that the private key share is terminated, through for example a display unit, a sound outputting unit, or a vibration unit.

If the received old private key is not the same as the stored private key, the AP 104 sends a private key configuration failure message (MKconfig_failure message) to the mobile terminal 100 (S206).

When the received count is equal to or smaller than the stored count, the AP 104 recognizes that a third party is involved in the private key share between the mobile terminal 100 and the AP 104. Only if the received count is greater than the stored count, the AP 104 sends the private key configuration complete message.

While the mobile terminal is shown in FIG. 2 as generating the private key, the AP may generates the private key according to setting of the user. That is, the AP may generate the private key using its own network information when receiving the private key configuration request message.

By performing the above-described exemplary processes, the mobile terminal 100 and the AP 104 share the new private key. The mobile terminal 100 is switched to the device mode in response to a request from the user. While the mobile terminal 100 and the AP 104 communicate with each other over the infrared channel, the present invention is not limited to an infrared channel. That is, the mobile terminal 100 and the AP 104 may communicate with each other over other local area communication channel.

FIG. 3 shows a process in which the device 102 and the AP 104 share a private key therebetween according to an exemplary embodiment of the present invention. A process in which the device 102 and the AP 104 share a private key therebetween according to an exemplary embodiment of the present invention will be now described in detail with reference to FIG. 3.

The mobile terminal 100 transmits a device key configuration request message (DK config_request message) to the device 102 over the infrared channel (S300). For convenience of illustration, a private key shared between the device and the AP is called a device key. The device key configuration request message is for requesting to transmit configuration information. After transmitting the device key configuration request message, the mobile terminal 100 increments its own count by one.

The device 102 transmits a device key configuration response message (DKconfig_response message) to the mobile terminal 100 over the infrared channel (S302). The device configuration response message includes a MAC address of the device. In response to receiving the device configuration response message, the mobile terminal 100 configures the device key using a stored private key, the received MAC address, and the count. When the mobile terminal 100 does not receive the device configuration response message within a set period of time, the mobile terminal 100 notifies the user that an error has occurred.

The mobile terminal 100 transmits a device configuration information message (DKconfig_info message) to the device 102 over the infrared channel (S304). The device configuration information message includes the device key generated in S302, and the SSID and the count stored in the mobile terminal 100. In response to receiving the device configuration information message, the device 102 determines whether the same SSID as the received SSID is stored in its own memory. If the same SSID as the received SSID is stored in the memory, the device 102 updates the memory with the received information. If the same SSID as the received SSID is not stored, the device 102 assigns a memory area to store the received information in the memory, and stores the received information into the assigned memory.

The device 102 then sends a device key configuration complete message (DKconfig_complete message) to the mobile terminal 100 over the infrared channel (S306). On the other hand, when an error occurs in the above-described process, the device 102 sends a device key configuration failure message (DKconfig_failure message) to the mobile terminal 100 over the infrared channel (S306). The device key configuration failure message includes information about causes of the error.

After transmitting the device key configuration complete message, the device 102 establishes a wireless channel to wirelessly communicate with the AP 104 (S308).

The device 102 transmits a WPA configuration request message (WPAconfig_request message) to the AP 104 (S310). The WPA configuration request message includes a random 1 obtained from a device key corresponding to the same SSID as the SSID of the current channel, the MAC address, and the count. The random 1 is a value that is randomly generated by the device 102.

In response to receiving the WPA configuration request message, the AP 104 proceeds to a subsequent process only if the received count is greater than the stored count. That is, if the received count is not greater than the stored count, the AP 104 regards the WPA configuration request message as a retransmission message. The AP 104 generates a device key using the received MAC address and the count. The AP 104 applies the generated device key and the received random1 to a one-directional function to calculate a first one-directional function operation value. The AP 104 further generates random 2. The random 2 is a value that is randomly generated by the AP 104.

The AP 104 transmits an authentication WPA configuration request message (AuthWPAconfig_request message) to the device 102 (S312). The authentication WPA configuration request message includes the first one-directional function operation value and the random 2. If the stored count is equal to or greater than the received count as described above, the AP 104 transmits a WPA configuration failure message (WPAconfig_failure message) to the device 102 (S312).

In response to receiving the authentication WPA configuration request message, the device 102 determines whether the value obtained by applying the device key and the random1 to the one-directional function is equal to the first one-directional function operation value. If the value is not equal to the first one-directional function operation value, the device 102 sends an authentication WPA configuration failure message (AuthWPAconfig_failure message) to the AP 104 (S312). If the value is equal to the first one-directional function operation value, the device 102 applies the device key and the random 2 to the one-directional function to calculate a second one-directional function operation value.

The device 102 then sends an authentication WPA configuration response message (AuthWPAconfig_response message) to the AP 104. The authentication WPA configuration response message includes the second one-directional function operation value.

In response to receiving the authentication WPA configuration response message, the AP 104 determines whether the value obtained by applying the stored device key and the random 2 to the one-directional function is equal to the second received one-directional function operation value. If the value is not equal to the second one-directional function operation value, the AP 104 sends a WPA configuration failure message (WPAconfig_failure message) to the device 102 (S316). If the value is equal to the second one-directional function operation value, the AP 104 writes device information to a registration device table. That is, the AP 104 stores the MAC address and the device key of the device 102 in the registration device table. The AP 104 updates and stores the count.

The AP 104 sends a WPA configuration complete message (WPAconfig_complete message) to the device 102 (S316). The above-described processes allow the device 102 and the AP 104 to authenticate each other. The device 102 performs a re-association process to terminate and extend the session (S318).

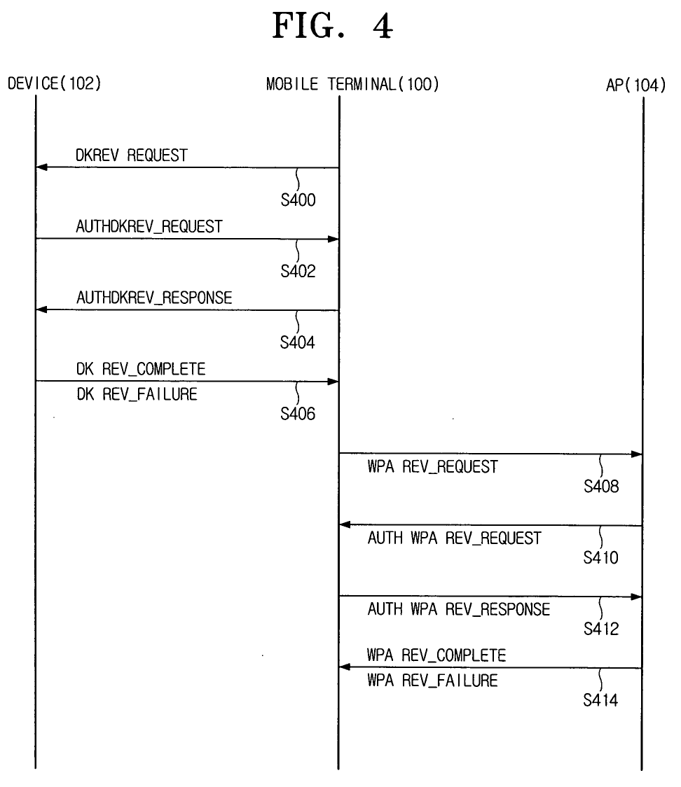

FIG. 4 shows a process in which the device 102 and the AP 104 discard an authenticated device key according to an exemplary embodiment of the present invention.

The device 102 stores a device key and the mobile terminal 100 stores a private key. The AP 104 stores the device key and the private key. The private key is shared between the device 102 and the mobile terminal 100 and is not distinct between devices. Thus, the step S200 is performed once on one mobile terminal and one AP.

The mobile terminal 100 sends a device key discard request message (DKrev_request message) to the device 102 (S400). The device key discard request message includes a SSID and a random a. The random a is a value that is randomly generated by the mobile terminal 100.

In response to receiving the device key discard request message, the device 102 searches for a device key corresponding to the SSID. The device 102 applies to the searched device key and the received random a to a one-directional function to calculate an a-th one-directional function operation value.

The device 102 sends an authentication device key discard request message (AuthDKrev_request message) to the mobile terminal 100 (S402). The authentication device key discard request message includes a MAC address and a random b of the device 102, a count, and an a-th one-directional function operation value. If there is no same SSID, the device 102 sends a device key failure message (DK_failure message) to the mobile terminal 100 (S402).

In response to receiving the authentication device key discard request message, the mobile terminal 100 generates the device key using the private key, the MAC address, and the count. The mobile terminal 100 determines whether a value obtained by applying the generated device key and the stored random a to the one-directional function is equal to the a-th received one-directional function operation value. If the value is not equal to the a-th received one-directional function operation value, the mobile terminal 100 sends an authentication device key discard failure message (AuthDKrev_failure message) to the device 102 (S404). If the value is equal to the a-th received one-directional function operation value, the mobile terminal 100 applies the device key and the random b to the one-directional function to generate a b-th one-directional function operation value.

The mobile terminal 100 sends an authentication device key discard response message (AuthDKrev_response message) to the device 102 (S404). The authentication device key discard response message includes the b-th one-directional function operation value. In response to receiving the authentication device key discard response message, the device 102 determines whether a value obtained by applying the stored device key and random b to the one-directional function is equal to the b-th received one-directional function operation value.

If the value is not equal to the b-th received one-directional function operation value, the device 102 sends a device key discard failure message (DKrev_failure message) to the mobile terminal 100 (S406). If the value is equal to the b-th received one-directional function operation value, the device 102 sends a device key discard complete message (DKrev_complete message) to the mobile terminal 100 (S406) and discards the stored information. When the mobile terminal 100 receives the device key discard complete message, the mobile terminal 100 recognizes that the device 102 discards the stored information. The mobile terminal 100 may write to a stored discard table a fact that the device 102 discards the stored information.

A process in which the information stored in the AP 104 is discarded will be now described.

The mobile terminal 100 sends a WPA discard request message (WPArev_request message) to the AP 104 (S408). The WPA discard request message is for requesting to discard the device 102 information stored in the AP 104. The WPA discard request message includes a random c, and a MAC address of the device 102. The random c is a value that is randomly generated by the mobile terminal 100.

In response to receiving the WPA discard request message, the AP 104 searches for a MAC address corresponding to an SSID. If there is no corresponding MAC address, the AP 104 sends a WPA discard failure (WPArev_failure) message (S410). If there is the MAC address, the AP 104 obtains a device key corresponding to the MAC address. The AP 104 calculates a c-th one-directional function operation value by applying a stored device key and the received random c to one-directional function operation. In addition, the AP 104 generates a random d.

The AP 104 sends an authentication WPA discard request message (AuthWPArev_request message) to the mobile terminal 100 (S410). The authentication WPA discard request message includes the random d and the c-th one-directional function operation value.

In response to receiving the authentication WPA discard request message, the mobile terminal 100 determines whether a value obtained by applying the stored device key and the random c to one-directional function is equal to the received c-th one-directional function operation value. If the value is not equal to the received c-th one-directional function operation value, the mobile terminal 100 sends an authentication WPA discard failure message (AuthWPArev_failure message) to the AP 104 (S412). If the value is equal to the received c-th one-directional function operation value, the mobile terminal 100 generates a d-th one-directional function operation value that is a value obtained by applying the device key and the random d to one-directional function.

The mobile terminal 100 sends an authentication WPA discard response message (AuthWPArev_response message) to the AP 104 (S412). The authentication WPA discard response message includes a d-th one-directional function operation value. In response to receiving the authentication WPA discard response message, the AP 104 determines whether a value obtained by applying the stored device key and the random d to one-directional function is equal to the d-th received one-directional function operation value.

If the value is not equal to the d-th received one-directional function operation value, the AP 104 sends a WPA discard failure message (WPArev_failure message) to the mobile terminal 100 (S414). If the value is equal to the d-th received one-directional function operation value, the AP 104 transmits a WPA discard complete message (WPArev_complete message) to the mobile terminal 100 and discards the stored device related information (S414). That is, the AP 104 discards the device MAC address and the device key stored in the registration device table. When the mobile terminal 100 receives the WPA discard complete message, the mobile terminal 100 recognizes that the AP 104 discards the stored information.

As described above, security of data against attack from a third party may be improved by sharing authentication information between the device and the AP using mobile terminal. That is, a more secure transmission and reception of data may be achieved by sharing the private key and the device key using a one-directional function generating module included in the mobile terminal and the AP.

While the invention has been shown and described with reference to certain exemplary embodiments thereof, it will be understood by those skilled in the art that various changes in form and details may be made therein without departing from the spirit and scope of the invention as defined by the appended claims and equivalents thereof.

What is claimed is:

1. A method for sharing a private key between a mobile terminal and an access point (AP), the method comprising:
transmitting a private key configuration request message to an access point (AP), the private key configuration request message comprising network information of a mobile terminal;
receiving a private key configuration response message from the AP, the private key configuration response message comprising network information of the AP;
generating a private key corresponding to the network information of the AP; and
transmitting a private key configuration information message comprising the private key.

2. The method as claimed in claim 1, wherein the mobile terminal and the AP use a local area communication channel for at least one of transmission and reception.

3. The method as claimed in claim 1, wherein the private key configuration information message comprises a previously stored private key.

4. The method as claimed in claim 3, further comprising incrementing a preset count when the private key configuration response message is received, the private key configuration information message comprising the incremented count.

5. The method as claimed in claim 3, further comprising receiving a private key configuration complete message instructing to share the private key from the AP when the previously stored private key is stored in the AP.

6. A method for sharing a device key between a mobile terminal and a device communicating with an access point (AP), the method comprising:
transmitting a device key configuration request message to a device communicating with an access point (AP);
receiving a device key configuration response message from the device, the device key configuration response message comprising network information of the device;
generating the device key based on a stored private key, a count, and the received network information of the device; and
transmitting a device key configuration information message comprising the generated device key.

7. The method as claimed in claim 6, wherein the network information of the device comprises an MAC address of the device.

8. The method as claimed in claim 6, wherein the device key configuration information message comprises a count stored in the mobile terminal and network information of the AP.

9. The method as claimed in claim 6, wherein the mobile terminal and the device use an infrared communication channel for at least one of transmission and reception.

10. A method for sharing a device key between a device communication with an access point (AP) and the AP, the method comprising:
sending a WPA configuration request message, the WPA configuration request message comprising a randomly generated random 1, a MAC address of a device communicating with an access point AP, and a count;
receiving an authentication WPA configuration request message, the authentication WPA configuration request message comprising a first one-directional function operation value obtained by applying the random 1 to one-directional function operation, and a randomly generated random 2; and
when a value obtained by applying the random 1 to the one-directional function operation is equal to the first one-directional function operation value, sending an authentication WPA configuration response message, the authentication WPA configuration response message comprising a second one-directional function operation value obtained by applying the received random 2 to the one-directional function operation.

11. The method as claimed in claim 10, wherein the device key is generated using the count and the MAC address, and the first one-directional function operation value is calculated using the generated device key and the random 1.

12. The method as claimed in claim 10, wherein the received random 2 and a pre-stored device key is used to calculate the second one-directional function operation value.

13. The method as claimed in claim 10, wherein a value obtained by applying the pre-stored random 2 to the one-directional function operation is equal to the second received one-directional function operation value, and wherein the AP sends to the device a WPA configuration complete message instructing to share the device key.

14. A method for a mobile terminal to instruct a device communicating with an access point (AP) to discard a stored device key, the method comprising:
sending a device key discard request message, the device key discard request message comprising a randomly generated random a and network information of an access point (AP);
receiving an authentication device key discard request message, the authentication device key discard request message comprising an a-th one-directional function operation value obtained by applying the random a and a pre-stored device key to one-directional operation, a randomly generated random b, and network information of the device;
generating the device key using a stored private key and the received network information of the device; and
sending an authentication device key discard response message when a value obtained by applying the generated device key and the random a to the one-directional operation is equal to the a-th one-directional function operation value, the authentication device key discard response message comprising a b-th one-directional function operation value obtained by applying the received random b to the one-directional function operation.

15. The method as claimed in claim 14, wherein the device discards the device key when a value obtained by applying the pre-stored device key and the random b to one-directional operation is equal to the b-th one-directional function operation value.

16. The method as claimed in claim 14, wherein the mobile terminal and the device use a local area communication channel for at least one of transmission and reception.

17. A method for a mobile terminal to instructing an access point AP communicating with a device to discard a stored device key, the method comprising:
sending a WPA discard request message, the WPA discard request message comprising a randomly generated random c and network information of a device communicating with an access point (AP);
receiving an authentication WPA discard request message, the authentication WPA discard request message comprising a c-th one-directional function operation value obtained by applying the random c and a pre-stored device key to one-directional operation, and a randomly generated random d; and
when a value obtained by applying the pre-stored device key and the receiving random c to the one-directional operation is equal to the c-th one-directional function operation value, sending an authentication WPA discard response message, the authentication WPA discard response message comprising a d-th one-directional function operation value obtained by applying the received random d to the one-directional function operation.

18. The method as claimed in claim 17, wherein the AP discards the device key when a value obtained by applying the pre-stored device key and the random value d to one-directional operation is equal to the d-th received one-directional function operation value.

19. A method for sharing a private key between a mobile terminal and an access point (AP), the method comprising:
transmitting a private key configuration request message to an access point (AP), the private key configuration request message comprising network information of a mobile terminal; and
transmitting a private key configuration information message, the private key configuration information message comprising a private key that corresponds to network information of the AP.

20. The method as claimed in claim 19, wherein the mobile terminal and the AP use a local area communication channel for at least one of transmission and reception.

21. The method as claimed in claim 19, wherein when the private key configuration information message comprises a previously stored private key.

22. A communication system comprising:
a device;
an access point (AP) communicating with the device; and
a mobile terminal communicating with the device and the AP;
wherein:
a private key configuration request message is transmitted to the AP, the private key configuration request message comprising network information of the mobile terminal;
a private key configuration response message is received from the AP, the private key configuration response message comprising network information of the AP;
a private key corresponding to the network information of the AP is generated; and
a private key configuration information message comprising the generated private key is transmitted.

23. The system as claimed in claim 22, wherein the mobile terminal and the AP are configured to use a local area communication channel for transmission and reception.

24. The system as claimed in claim 22, wherein the private key configuration information message comprises a previously stored private key.

25. The system as claimed in claim 24, wherein a preset count is incremented when the private key configuration response message is received, the private key configuration information message comprising the incremented count.

26. The system as claimed in claim 24, wherein, when the previously stored private key is stored in the AP, a private key configuration complete message instructing to share the private key is received from the AP.

27. The system as claimed in claim 22 wherein:
a device key configuration request message is transmitted to the device;
a device key configuration response message is received from the device, the device key configuration response message comprising network information of the device;
the device key is generated based on a stored private key, a count, and the received network information of the device; and
a device key configuration information message comprising the generated device key is transmitted.

28. The system as claimed in claim 27, wherein the network information of the device comprises an MAC address of the device.

29. The system as claimed in claim 27, wherein the device key configuration information message comprises a count stored in the mobile terminal and network information of the AP.

30. The system as claimed in claim 27, wherein the mobile terminal and the device are configured to use infrared communication channel for transmission and reception.

31. The system as claimed in claim 22, wherein:
a WPA configuration request message is sent, the WPA configuration request message comprising a randomly generated random 1, and an MAC address of the device and a count;
an authentication WPA configuration request message is received, the authentication WPA configuration request message comprising a first one-directional function operation value obtained by applying the random 1 to one-directional function operation, and a randomly generated random 2; and
when a value obtained by applying the random 1 to the one-directional function operation is equal to the first one-directional function operation value, sending an authentication WPA configuration response message, the authentication WPA configuration response message comprising a second one-directional function operation value obtained by applying the received random 2 to the one-directional function operation.

32. The system as claimed in claim 31, wherein the device key is generated using the count and the MAC address, and the first one-directional function operation value is calculated using the generated device key and the random 1.

33. The system as claimed in claim 32, wherein the received random 2 and a pre-stored device key is used to calculate the second one-directional function operation value.

34. The system as claimed in claim 32, wherein a value obtained by applying the pre-stored random 2 to the one-directional function operation is equal to the second received one-directional function operation value, and wherein the AP sends to the device a WPA configuration complete message instructing to share the device key.

35. The system including as claimed in claim 22, wherein:
a device key discard request message is sent, the device key discard request message comprising a randomly generated random a and network information of the AP;
an authentication device key discard request message is received, the authentication device key discard request message comprising an a-th one-directional function operation value obtained by applying the random a and a pre-stored device key to one-directional operation, a randomly generated random b, and network information of the device;
the device key is generated using a stored private key and the received network information of the device; and
an authentication device key discard response message is sent when a value obtained by applying the generated device key and the random a to the one-directional operation is equal to the a-th one-directional function operation value, the authentication device key discard response message comprising a b-th one-directional function operation value obtained by applying the received random b to the one-directional function operation.

36. The system as claimed in claim 35, wherein the device discards the device key when a value obtained by applying the pre-stored device key and the random b to one-directional operation is equal to the b-th one-directional function operation value.

37. The system as claimed in claim 35, wherein the mobile terminal and the device are configured to use a local area communication channel for transmission and reception.

38. The system as claimed in claim 22, wherein:
a WPA discard request message is sent, the WPA discard request message comprising a randomly generated random c and network information of the AP device;
an authentication WPA discard request message is received, the authentication WPA discard request message comprising a c-th one-directional function operation value obtained by applying the random c and a pre-stored device key to one-directional operation, and a randomly generated random d; and
when a value obtained by applying the pre-stored device key and the receiving random c to the one-directional operation is equal to the c-th one-directional function operation value, an authentication WPA discard response message is sent, the authentication WPA discard response message comprising a d-th one-directional function operation value obtained by applying the received random d to the one-directional function operation.

39. The system as claimed in claim 38, wherein the AP discards the device key when a value obtained by applying the pre-stored device key and the random value d to one-directional operation is equal to the d-th received one-directional function operation value.
